(19) United States
(12) Patent Application Publication
(10) Pub. No.: US 2018/0160285 A1
(43) Pub. Date: Jun. 7, 2018

(54) INFORMATION PROCESSING SYSTEM FOR MOBILE OBJECT, SERVER FOR MANAGING MOBILE OBJECT, INFORMATION COMMUNICATION TERMINAL AND MOBILE OBJECT

(71) Applicant: Panasonic Intellectual Property Management Co., Ltd., Osaka (JP)

(72) Inventors: Yukiko OKINAGA, Osaka (JP); Jitsu OKUMURA, Kyoto (JP)

(21) Appl. No.: 15/870,476

(22) Filed: Jan. 12, 2018

Related U.S. Application Data
(63) Continuation of application No. PCT/JP2016/003321, filed on Jul. 14, 2016.

(30) Foreign Application Priority Data
Jul. 22, 2015 (JP) 2015-145075

(51) Int. Cl. H04W 4/80; B64C 39/02; B64C 27/08

(52) U.S. Cl. CPC H04W 4/80; H04B 5/0031; B64C 27/08; B64C 39/024

(57) ABSTRACT

An information processing system for a mobile object including: a mobile object pilot license; a mobile object including a first IC tag; an information communication terminal contactlessly communicating with the mobile object; and a server communicating with the information communication terminal over a network, wherein the information communication terminal transmits to the server first data that is data on the mobile object pilot license and second data that is data on the mobile object read into the information communication terminal through contactless communication, the server performs a predetermined judgment process based on the first data and the second data, and transmits third data that is based on a result of the judgment process to the information communication terminal, and the information communication terminal transmits a signal corresponding to the third data to the mobile object to permit or restrict an operation of the mobile object in accordance with the signal.

### CROSS REFERENCE TO RELATED APPLICATIONS

This application is a U.S. continuation application of PCT International Patent Application Number PCT/JP2016/003321 filed on Jul. 14, 2016, claiming the benefit of priority of Japanese Patent Application Number 2015-145075 filed on Jul. 22, 2015, the entire contents of which are hereby incorporated by reference.

### BACKGROUND

### 1. Technical Field

The present disclosure relates to an information processing system for a mobile object, and particularly to an information processing system suitable for safe operation of a mobile object.

### 2. Description of the Related Art

In recent years, self-controlling mobile objects including unmanned aircrafts known as drones have attracted attention, contributing to a growing development of the related industries. For example, Japanese Unexamined Patent Application Publication No. 2010-58779 discloses a remotely piloted flying robot that includes a plurality of rotary blades.

The use of such mobile objects ranges from entertainment to transportation of goods. Moreover, mobile objects are of significant use for the assessment of situations at areas that are difficult for humans to approach such as dark or narrow spaces, and dangerous areas where there is leakage of radiation or poisonous gas.

### SUMMARY

Meanwhile, mobile object-related accidents and incidents frequently occur such as drones falling and entering important facilities. So far, there is no explicit rule for operating mobile objects, and thus anyone can freely operate mobile objects regardless of place, time, their operation skills, and compensation capabilities. While necessary regulations and guidelines are under development by governmental and related organizations, it is highly possible that those who are ignorant of the regulations or guidelines might operate mobile objects in prohibited areas, for example, even after the rules are put into effect. To cope with these concerns, it is a pressing issue to provide a system that enables safe and secure operation of mobile objects.

The information processing system for a mobile object according to one aspect of the present disclosure is an information processing system for a mobile object including: a mobile object pilot license; a mobile object including a first IC tag; an information communication terminal that contactlessly communicates with the mobile object; and a server that communicates with the information communication terminal over a network. Here, the information communication terminal transmits first data and second data to the server, the first data being data on the mobile object pilot license, the second data being data on the mobile object read into the information communication terminal through contactless communication, the server performs a predetermined judgment process based on the first data and the second data, and transmits third data that is based on a result of the predetermined judgment process to the information communication terminal, and the information communication terminal transmits a signal corresponding to the third data to the mobile object to permit or restrict an operation of the mobile object in accordance with the signal.

According to the information processing system for the mobile object of the present disclosure, the server judges whether to permit the flight of the mobile object on the basis of the information on the mobile object pilot license and the information on the mobile object transmitted from the information communication terminal, and the information communication terminal that has received the judgment result transmits to the mobile object a signal for permitting or restricting the operation of the mobile object. This enables safe and secure operation of the mobile object.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram that schematically shows the configuration of an information processing system according to Embodiment 1;

FIG. 2 is a diagram that schematically shows the structure of a mobile object pilot license of the information processing system according to Embodiment 1;

FIG. 3 is a diagram that schematically shows the configuration of a mobile object of the information processing system according to Embodiment 1;

FIG. 4A is a diagram showing an example operation of the information processing system according to Embodiment 1;

FIG. 4B is a diagram showing an example operation of the information processing system according to Embodiment 1;

FIG. 4C is a diagram showing an example operation of the information processing system according to Embodiment 1;

FIG. 4D is a diagram showing an example operation of the information processing system according to Embodiment 1;

FIG. 4E is a diagram showing an example operation of the information processing system according to Embodiment 1;

FIG. 4F is a diagram showing an example operation of the information processing system according to Embodiment 1;

FIG. 5 is a flowchart of an example judgment process performed by a server of the information processing system according to Embodiment 1;

FIG. 6 is a diagram showing an example of data included in the mobile object of the information processing system according to Embodiment 1;

FIG. 7 is a diagram showing an example database included in the server of the information processing system according to Embodiment 1;

FIG. 8 is a diagram showing an example of data included in the mobile object pilot license of the information processing system according to Embodiment 1;

FIG. 9 is a diagram showing an example database included in the server of the information processing system according to Embodiment 1;

FIG. 10 is a diagram showing an example database included in the server of the information processing system according to Embodiment 1;

FIG. 11 is a flowchart of an example judgment process performed by the server of the information processing system according to Embodiment 1;

FIG. 12 is a diagram showing a part of an information processing system according to a variation of Embodiment 1;

FIG. 13 is a diagram showing a part of an information processing system according to another variation of Embodiment 1;

FIG. 14 is a diagram showing a part of an information processing system according to still another variation of Embodiment 1;

FIG. 15 is a diagram that schematically shows the configuration of an information processing system according to still another variation of Embodiment 1; and

FIG. 16 is a diagram that schematically shows the configuration of an information processing system according to still another variation of Embodiment 1.

### DETAILED DESCRIPTION OF THE EMBODIMENT

The following describes the embodiment according to the present disclosure with reference to the drawings. The same components are assigned with the same reference marks throughout the drawings, and duplicated descriptions are omitted where necessary.

Note that the following embodiment shows an exemplary illustration of the present disclosure. The numerical values, shapes, materials, structural components, the arrangement and connection of the structural components, steps, the processing order of the steps etc. shown in the following embodiment are mere examples, and therefore are not intended to limit the present disclosure. Of the structural components described in the following embodiment, structural components not recited in any one of the independent claims that indicate the broadest concepts of the present disclosure will be described as optional structural components.

### Embodiment 1

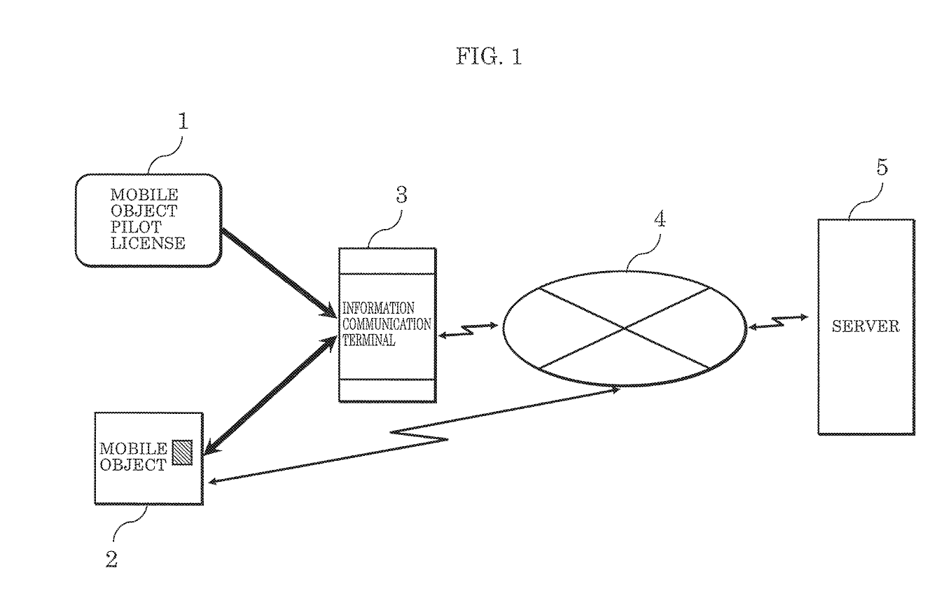

FIG. 1 is a diagram showing an entire configuration of the system according to Embodiment 1.

The system illustrated in FIG. 1 is an information processing system for a mobile object, including mobile object pilot license 1, mobile object 2 that includes an IC tag, information communication terminal 3, network 4, and server 5. Stated differently, the present system includes information communication terminal 3 configured to contactlessly communicate with mobile object 2 and server 5 configured to communicate with information communication terminal 3 over network 4. Information communication terminal 3 may also communicate with mobile object pilot license 1 contactlessly, and server 5 may communicate with mobile object 2 over network 4.

The following describes in detail about the components of the system.

### (Mobile Object Pilot License)

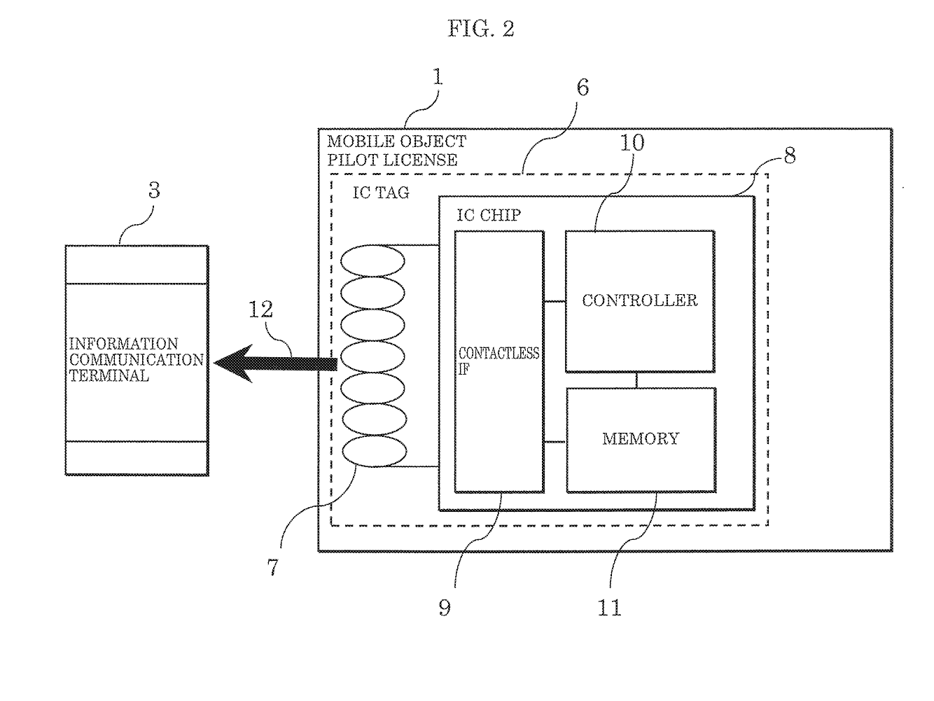

Mobile object pilot license 1 is a certificate for flying a mobile object to be granted to an individual by a predetermined organization. Mobile object pilot license 1 includes data for identifying the owner of the license. For example, a unique license number is recorded onto an internal memory of an IC tag, and a card, an insurance certificate, or another object embedded with the IC tag is issued as the license. Alternatively, electric data including a unique license number is stored onto an electric device owned by the individual. FIG. 2 shows an exemplary illustration of mobile object pilot license 1 embedded with an IC tag.

As illustrated in FIG. 2, mobile object pilot license 1 includes IC tag 6 that enables mobile object pilot license 1 to contactlessly communicate with information communication terminal 3. IC tag 6 includes antenna 7 and IC chip 8. Antenna 7 is connected to contactless IF 9 included in IC chip 8. IC tag 6 is of a passive type that is driven by radio waves from the reader/writer of information communication terminal 3, and thus requires no internal battery.

Contactless IF 9 is an example interface for contactless exterior communication. Contactless IF 9 includes the following components (not illustrated): analogue circuits such as a rectification circuit, a demodulation circuit, a modulation circuit, and a clock regeneration circuit; digital circuits such as circuits for encoding of transmitted and received data, for detection and generation of frames, and for cyclic redundancy check (CRC); and a transmission and reception buffer for temporary storage of transmitted and received data.

Contactless IF 9 detects whether the magnetic field from the reader/writer of information communication terminal 3 is above a predetermined threshold, and notifies controller 10 of the detection result.

Controller 10 drives IC tag 6 to obtain a command instructing data access from the reader/writer of information communication terminal 3. Controller 10 accesses the data in memory 11 indicated by the command, i.e., controller 10 accesses a predetermined region in memory 11 to retrieve data stored in the region. The retrieved data is read into the reader/writer of information communication terminal 3 via contactless IF 9 and antenna 7.

Memory 11 serves as a temporary or permanent storage of data in communication with information communication terminal 3. Memory 11 is, for example, a nonvolatile memory in which data is retained even when there is no power supply.

As described above, mobile object pilot license 1 is configured to receive power supply by including IC tag 6 so that mobile object pilot license 1 receives radio waves transmitted from outside mobile object pilot license 1 at contactless IF 9 via antenna 7. Then, controller 10 transmits to the outside response (response signal) 12 corresponding to a data access request from information communication terminal 3. Here, response 12 includes, for example, data of a license number unique to mobile object pilot license 1.

### (Mobile Object)

Mobile object 2 is an autonomous locomotion robot that can be hand-operated or remotely controlled through a program. The present embodiment describes mobile object 2 as an aircraft (drone) including a plurality of propellers, but the present disclosure is not limited to this example. For example, mobile object 2 may be: an aircraft other than a propeller-driven type; a mobile object that moves on and under the water and the ground; or a mobile object that moves up and down a wall surface.

Mobile object 2 includes data for identifying the owner of mobile object 2. For example, information unique to mobile object 2 (e.g., individual identification number) is recorded onto an internal memory of the IC tag of mobile object 2 when mobile object 2 is manufactured or purchased.

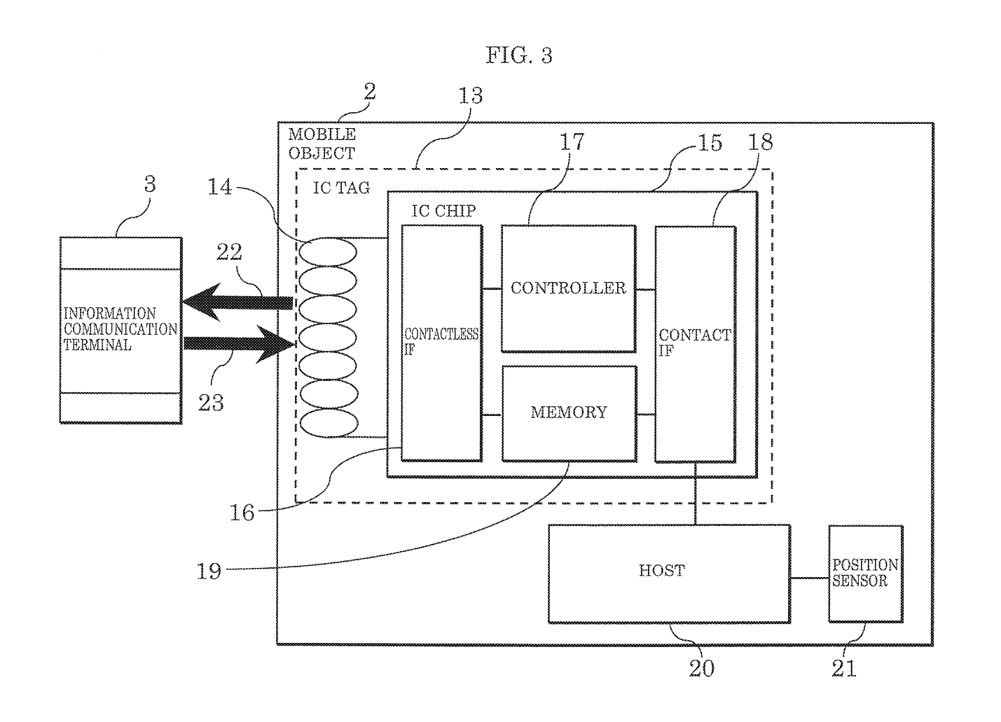

FIG. 3 shows an exemplary configuration of mobile object 2 including IC tag 13 that enables mobile object 2 to contactlessly communicate with information communication terminal 3. IC tag 13 includes antenna 14 and IC chip 15. Antenna 14 is connected to contactless IF 16 included in IC chip 15.

Contactless IF 16 is an example interface for contactless exterior communication. The circuit configuration of contactless IF 16 is the same as that of contactless IF 9 described above, and thus will not be described here. Contactless IF 16 detects whether the magnetic field from the reader/writer of information communication terminal 3 is above a predetermined threshold, and notifies controller 17 of the detection result.

Controller 17 is connected to contactless IF 16, contact IF 18, and memory 19. Controller 17 drives IC tag 13 to notify host 20 of the detection result from contact IF 18. Host 20 supplies power to position sensor 21 to cause position sensor 21 to detect the current position of mobile object 2.

Position sensor 21 is, for example, a global positioning system (GPS) unit having the GPS function. Position sensor 21 outputs data on longitude, latitude and altitude, which is positional information of mobile object 2. The positional information of mobile object 2 is sent to memory 19 of IC tag 13 via contact IF 18 for temporary storage.

Controller 17 obtains a command instructing data access from the reader/writer of information communication terminal 3. Controller 17 accesses a predetermined region in memory 19 indicated by the command to retrieve data stored in the region. The retrieved data is read into the reader/writer of information communication terminal 3 via contactless IF 16 and antenna 14.

IC tag 13 is of a passive type that is driven by radio waves from the reader/writer of information communication terminal 3, but the present disclosure is not limited to this example. Host 20 that has been notified of the detection result may supply power to IC tag 13.

Contact IF 18 is an example communication interface for wire communication with host 20. Contact IF 18 includes such components as an input/output circuit, a communication protocol processing circuit, and a transmission and reception buffer. Contact IF 18 is connected to power supply voltage VDD and a communication line for transmission and reception signals (not illustrated) so as to handle communication with host 20.

Memory 19 serves as a temporary or permanent storage of data in communications with host 20 and information communication terminal 3. Memory 19 is a nonvolatile memory in which data is retained even when mobile object 2 is powered off.

As described above, mobile object 2 is configured to receive power supply by including IC tag 13 and host 20 so that mobile object 2 receives radio waves transmitted from outside mobile object 2 at contactless IF 16 via antenna 14. Host 20 is configured to communicate with IC tag 13 via contact IF 18, and stores predetermined information on mobile object 2 (e.g., data on the current position obtained by position sensor 21) into memory 19. Controller 17 transmits to outside response (response signal) 22 corresponding to a data access request from information communication terminal 3. Here, response 22 includes, for example, the individual identification number, and longitude and latitude data of the current position of mobile object 2.

Moreover, mobile object 2 is configured to receive a signal from outside via IC tag 13 to self-control its own operation based on the received signal. For example, mobile object 2 receives, via antenna 14 and contactless IF 16, signal 23 including a predetermined command from the reader/writer of information communication terminal 3. When judging that the obtained command is an instruction concerning the power source, controller 17 notifies host 20 of such command via contact IF 18. Accordingly, host 20 accesses a power control unit (not illustrated) to turn the power on from the off state.

Note that the present Specification assumes that IC tag 13 is disposed in the main unit responsible for flight control, out of a plurality of electrical units included in mobile object 2, but the present disclosure is not limited to this example.

### (Information Communication Terminal)

Information communication terminal 3 is a communication-capable terminal such as a smartphone and a personal computer. Information communication terminal 3 may also be a controller of mobile object 2. Information communication terminal 3 includes a contactless interface that enables information communication terminal 3 to contactlessly communicate with IC tag 6 included in mobile object pilot license 1 or IC tag 13 included in mobile object 2, and has reader/writer function to be performed on IC tag 6 and IC tag 13. Information communication terminal 3 is configured to communicate with network 4 to be described below. Any communication system may be employed for communication between information communication terminal 3 and network 3, and thus a wireless communication system may be employed. Note that there may be a plurality of information communication terminals 3.

Information communication terminal 3 stores data on mobile object pilot license 1 and data read from mobile object 2. These items of data are transmitted to server 5 as a request over network 4. An example of the request is a command asking for flight permission of mobile object 2. Upon receiving from server 5 a response to the request, information communication terminal 3 stores data included in the response signal, and notifies the user of information that is based on the response signal by displaying such information on the monitor. An example of the information displayed on the monitor is information indicating that the flight of mobile object 2 is permitted. Information communication terminal 3 further transmits as signal 23 a command corresponding to the response from server 5 to mobile object 2 through contactless communication.

### (Network)

Network 4 may be any network connectable to information communication terminal 3, mobile object 2, and server 5. Network 4 thus may have any scale and topology, and may employ any connection method and communication protocol. Network 4 may be, for example, the Internet.

### (Server)

Server 5 may have any configuration that enables server 5 to transmit and receive data to and from mobile object 2 and information communication terminal 3 over network 4. Server 5 includes a recording device that stores information corresponding to the license number of mobile object pilot license 1 and information corresponding to the individual identification number of mobile object 2. The items of data stored in the recording device are managed as databases. Server 5 further includes an arithmetic unit that compares received data with data in a database to perform a judgment process.

Example items of information stored in the databases of server 5 include: information on mobile object pilot license 1 (license number, personal information on the owner, expiration date of the license, license level, total flight hours, accident history, insurance information, etc.); information on the mobile object (individual identification number, personal information on the owner, insurance information, failure information, maintenance history, weight, dealer, etc.); information on the components of the mobile object (total hours of use, time for replacement, failure information, etc.); and information on flight prohibitions or restrictions (position, date/time, restricted range/functions, wind speed, humidity, altitude, temperature, etc.).

In addition to the databases, items of data stored in the recording device include: a map or geographical information; the position of a power charging station; a control program to be downloaded by mobile object 2; and image data transmitted from mobile object 2 over network 4.

Note that server 5 may be a single server or may be composed of a plurality of servers. Alternatively, server 5 may be a group of virtual servers such as a cloud server.

### (Basic Operation of System)

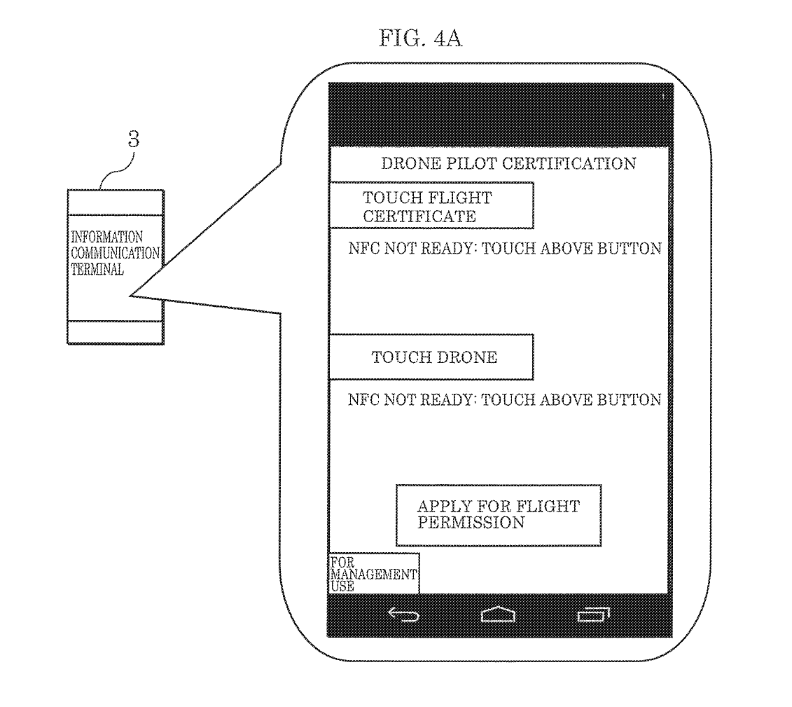

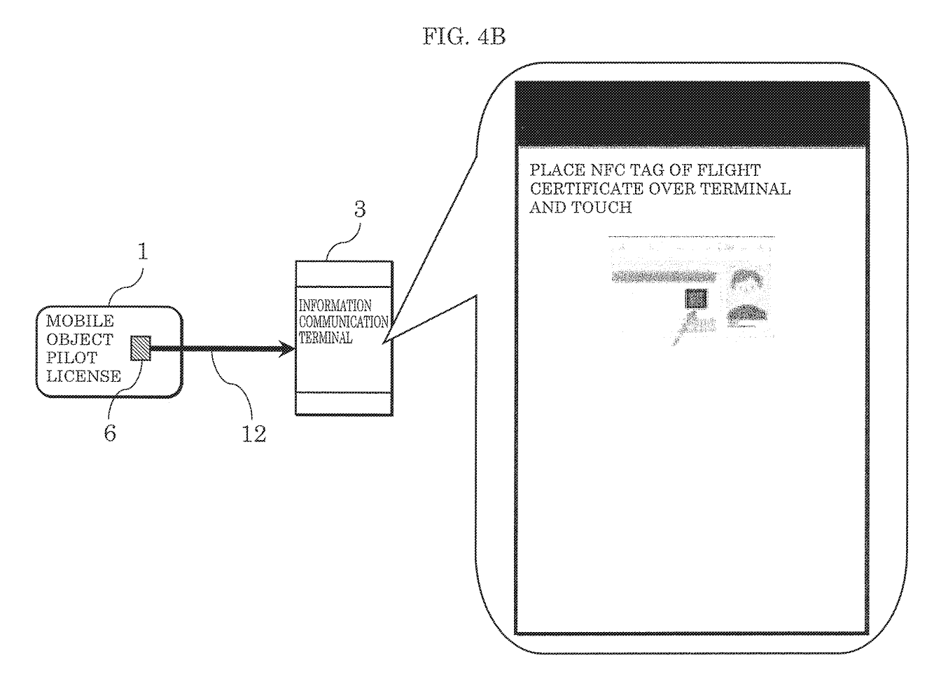

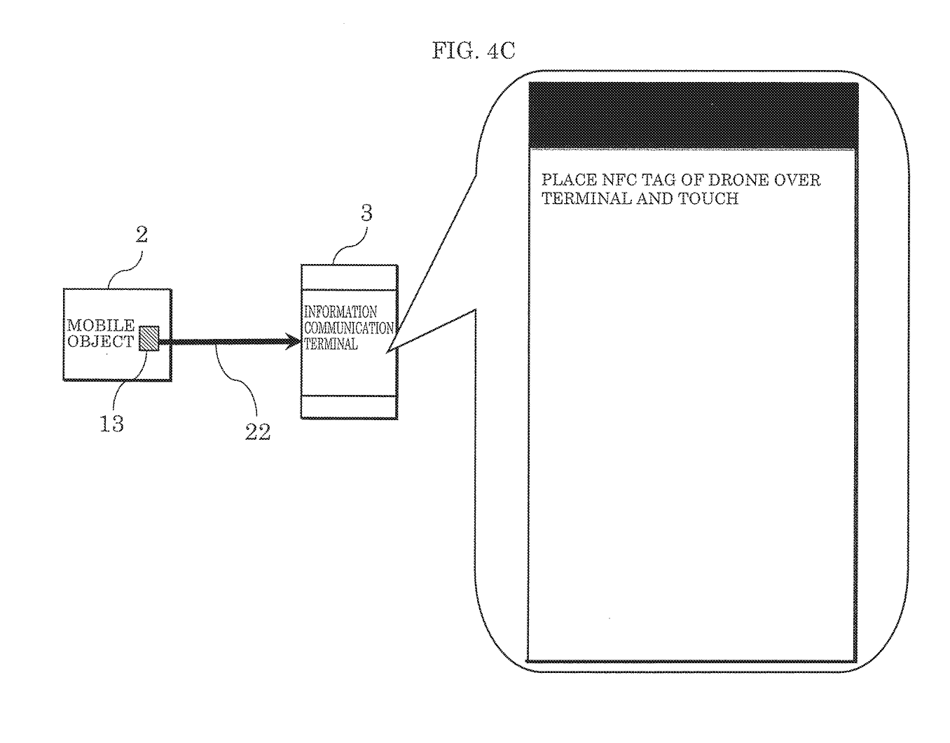

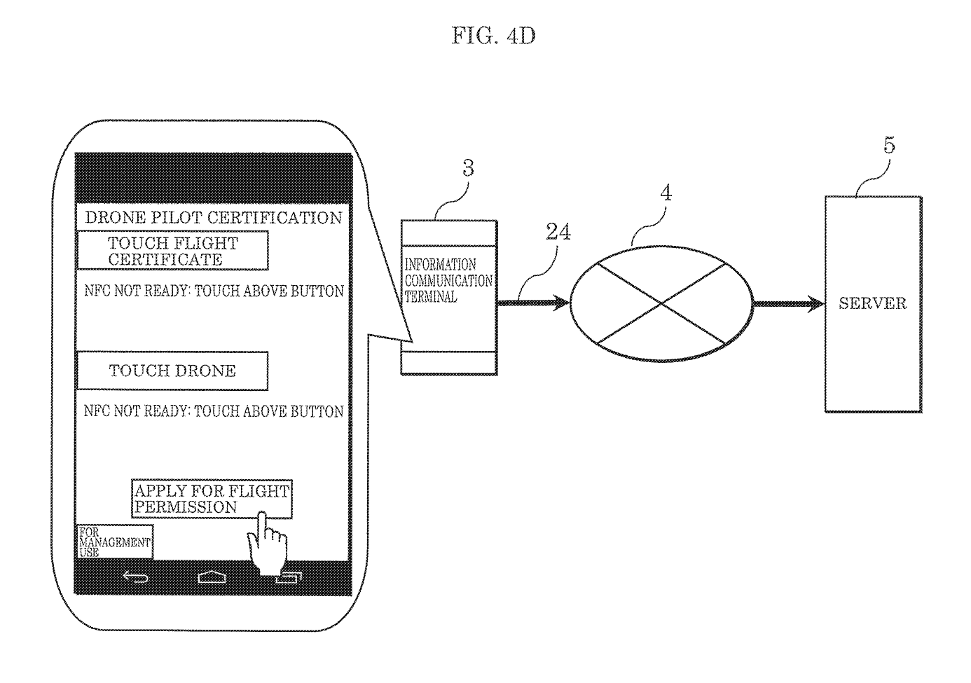

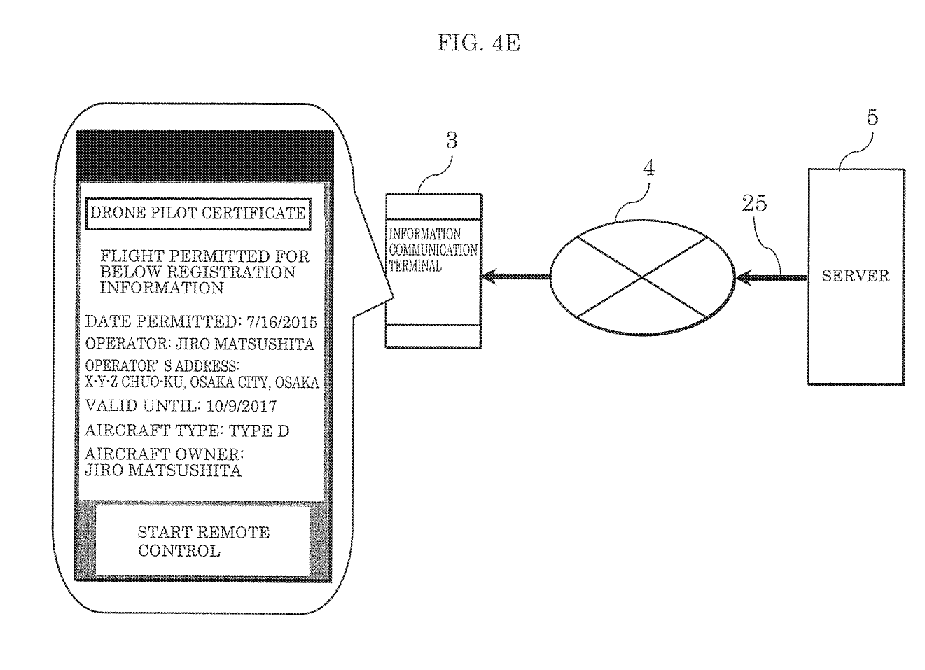

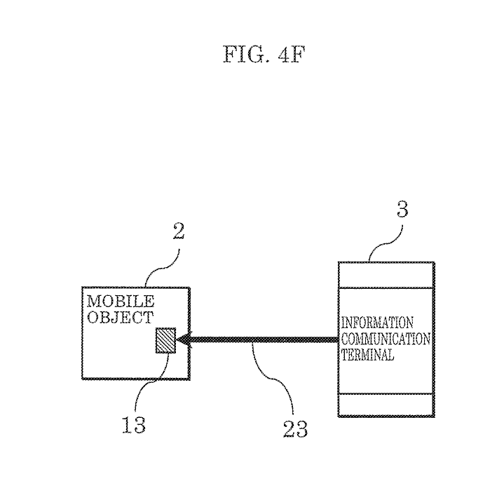

With reference to FIG. 4A to FIG. 4F, the following describes the basic operation of the system. The following description introduces a user of the system for a better understanding of the present disclosure, but such user is not an essential constituent element of the present disclosure.

First, as illustrated in FIG. 4A, the user activates an application in information communication terminal 3 to obtain flight permission of mobile object 2.

Next, as illustrated in FIG. 4B, information communication terminal 3 contactlessly communicates with IC tag 6 of mobile object pilot license 1 to read the license number data from response 12. This step may be executed by the user (the owner of mobile object pilot license 1) holding information communication terminal 3 over mobile object pilot license 1 in accordance with the guidance of the application.

Next, as illustrated in FIG. 4C, information communication terminal 3 contactlessly communicates with IC tag 13 of mobile object 2 to read from response 22 the data on the individual identification number and the current position of the mobile object 2. This step may be executed by the user (the owner of mobile object pilot license 1) holding information communication terminal 3 over mobile object 2 in accordance with the guidance of the application.

Next, as illustrated in FIG. 4D, information communication terminal 3 transmits to the outside data 24 that includes first data (the license number) read from mobile object pilot license 1 and second data (the individual identification number, the current position, etc.) read from mobile object 2. Data 24 is transmitted to server 5 over network 4 as a request for flight permission.

Next, as illustrated in FIG. 4E, server 5 compares the database information with the first data and the second data to judge whether flight permission is grantable. Server 5 outputs judgment result 25 as a response to information communication terminal 3. Information communication terminal 3 receives judgement result 25 over network 4 and displays judgment result 25 on the monitor.

Finally, as illustrated in FIG. 4F, information communication terminal 3 transmits signal 23 that includes a command corresponding to judgment result 25 to mobile object 2 through contactless communication. Here, such command includes an instruction for turning on the power of mobile object 2. Accordingly, mobile object 2 turns the power on from the off state in accordance with the command included in signal 23.

Note that in addition to being information indicating flight permission or flight prohibition, judgment result 25 may be data that includes other database information of server 5, such as information on the operator and information on the owner of mobile object 2 as illustrated. Similarly, in addition to the command indicating the power control of mobile object 2, signal 23 may include information on the operator (e.g., license number) obtained from mobile object pilot license 1. In such a case, information on the operator is temporarily stored, for example, into memory 19 of IC tag 13.

### (Flight Permission Judgment Process 1)

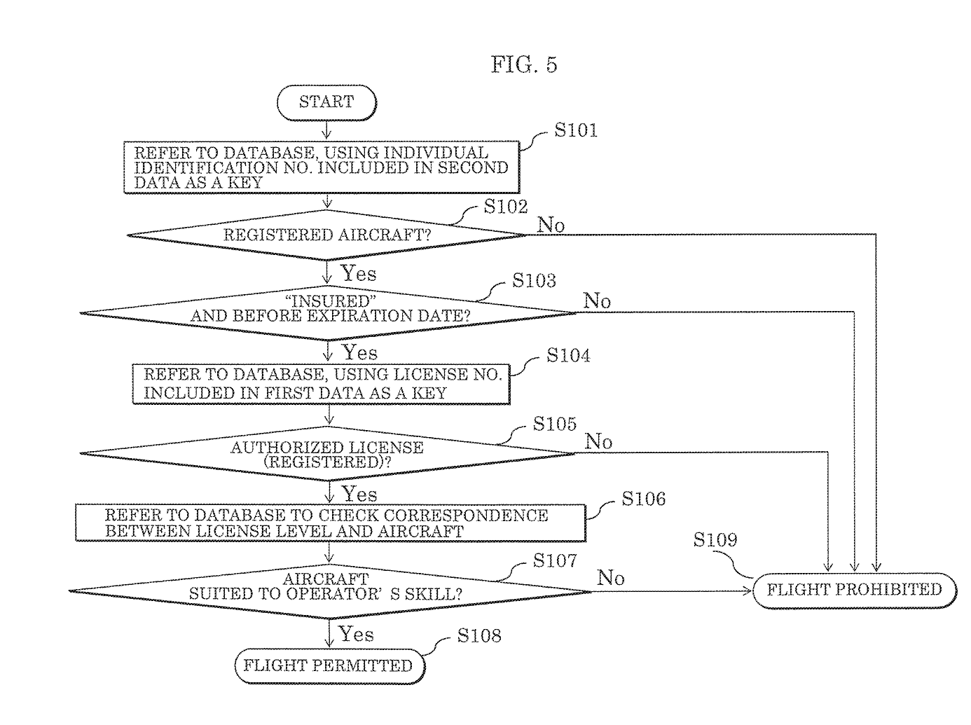

FIG. 5 is a flowchart showing an example process of comparison and judgment performed by server 5 of the system.

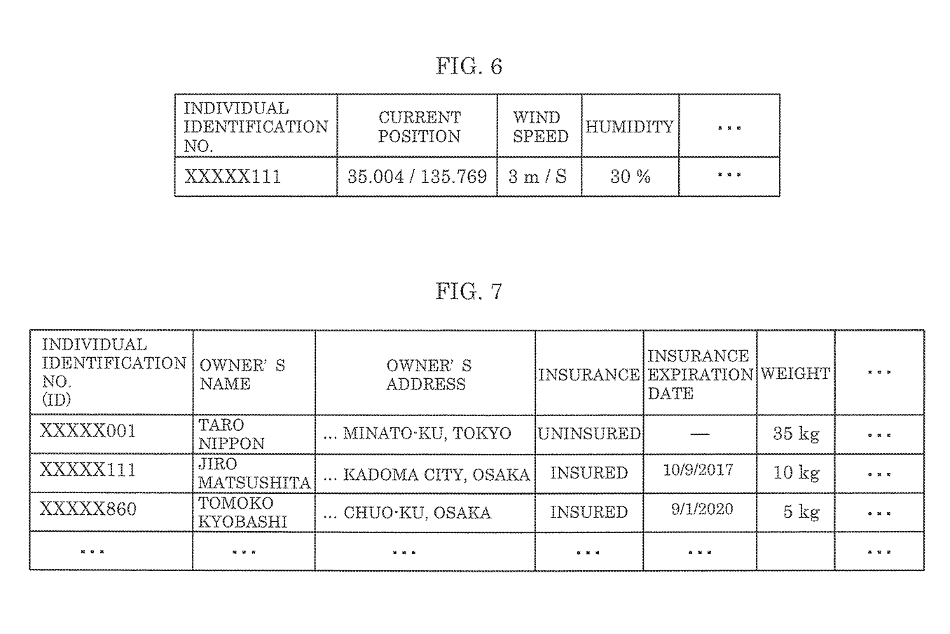

First, server 5 obtains the individual identification number “XXXXX111” from the second data, i.e., the data (shown in FIG. 6) read by information communication terminal 3 from mobile object 2. Then, server 5 accesses its database A (shown in FIG. 7) that stores information on mobile objects to check for the presence or absence of the matching data, using the obtained individual identification number as a search key (S101). Sets of plural items are registered in database A, such as “owner's name,” “insurance,” and “weight” of mobile objects, with “individual identification number” as a key (ID).

When database A doses not store the matching individual identification number (No in S102), server 5 terminates the judgment process. Stated differently, server 5 returns a response indicating flight prohibition, regarding that mobile object 2 is an unauthorized individual without authorized registration in database A (S109).

Meanwhile, when database A stores the matching data (Yes in S102), server 5 refers to the items of “insurance” and “insurance expiration date” in the same row (S103). In this example, the second row in database A hits.

When mobile object 2 is uninsured, or mobile object 2 is insured but the insurance is expired (No in S103), server 5 terminates the judgment process and returns a response indicating flight prohibition (S109). Meanwhile, when mobile object 2 is insured and the insurance is valid (Yes in S103), sever 5 proceeds to the following step. In this example, the item “insurance” is “insured” and the request for flight permission is made on Jul. 16, 2015, which is before the expiration date “10/09/2017,” and thus server 5 proceeds to the following step.

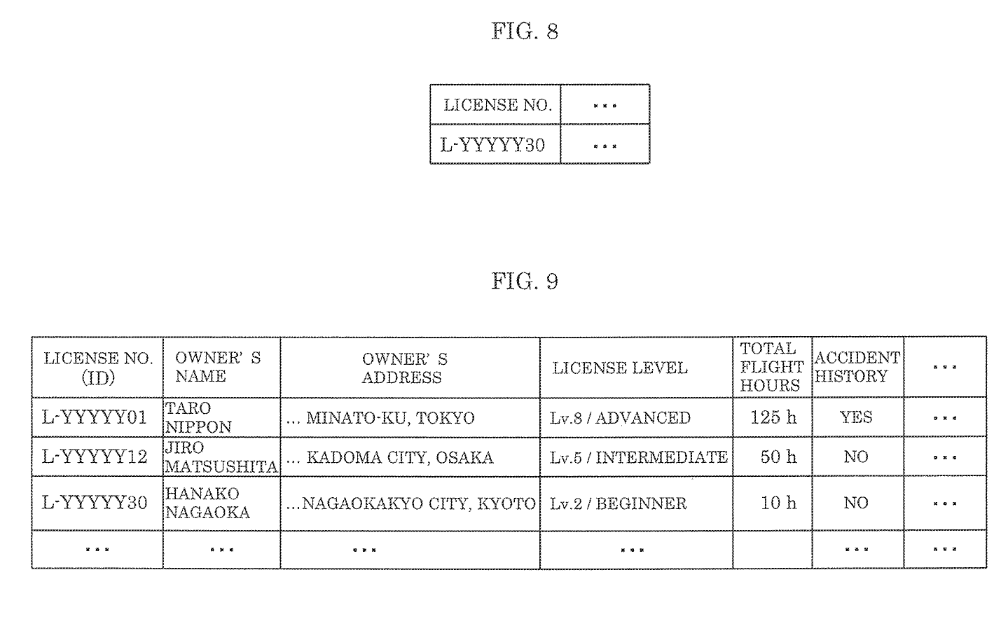

Then, server 5 obtains the license number “L-YYYYY30” from the first data, i.e., the data (shown in FIG. 8) read by information communication terminal 3 from mobile object pilot license 1. Then, server 5 accesses its database B (shown in FIG. 9) that stores information on mobile object pilot license 1 to check for the presence or absence of the matching data, using the obtained license number as a search key (S104). Sets of plural items are registered in database B, such as “owner's name” and “license level,” with “license number” as a key (ID).

When database B doses not store the matching license number (No in S105), server 5 terminates the judgment process. Stated differently, server 5 returns a response indicating flight prohibition, regarding that the owner is an unauthorized operator without authorized registration in database B (S109). In this example, the third row in database B hits.

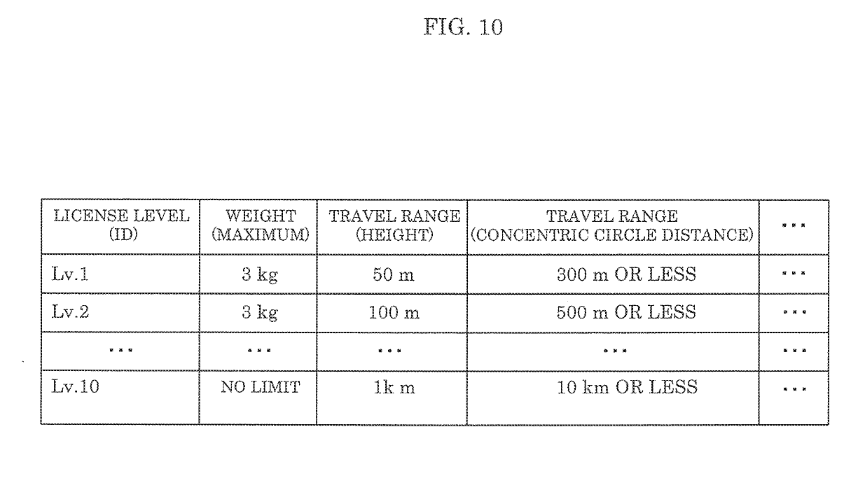

Meanwhile, when database B stores the matching data (Yes in S105), server 5 obtains the data of “license level” in the same row to access another database C (shown in FIG. 10), using the obtained data as a search key, and checks for the presence or absence of the matching data (S106). Sets of plural items are registered in database C, such as “weight” of a mobile object supported by the license level, “range (height)” of flight, with “license level” as a key (ID). In this example, “license level” of “L-YYYY30” in database B is “Lv.2,” and using this as a search key, the second row in database C hits.

Here, server 5 compares the value of “weight” of the matching license level with the value of “weight” of the matching mobile object found by the search in database A.

When the weight of the matching mobile object found in database A is heavier (No in S107), server 5 terminates the judgment process. Stated differently, server 5 judges that the owner is trying to fly a mobile object that exceeds the range permitted by the license, and returns a response indicating flight prohibition (S109). Meanwhile, when the weight of the matching mobile object found in database A is equal to or less than the weight supported by the matching license level found in database C, server 5 judges that the owner is trying to fly a mobile object that falls within the range permitted by the license (Yes in S107). Server 5 terminates the judgment process at this point, and returns a response indicating flight permission (S108). In this example, the “weight” of the matching mobile object found in database A is “10 kg,” while “weight” of a mobile object permitted by the matching license found in database C is “3 kg”, and thus server 5 returns a response of “fight prohibited,” judging that the owner is trying to fly a mobile object that is beyond such owner's license (skills).

Note that upon receiving the response, information communication terminal 3 notifies the user of the judgment result by displaying on the monitor “flight permitted” or “flight prohibited,” together with its reason (e.g., when the flight is to be prohibited, “you cannot operate this aircraft with your license”).

### (Flight Permission Judgment Process 2)

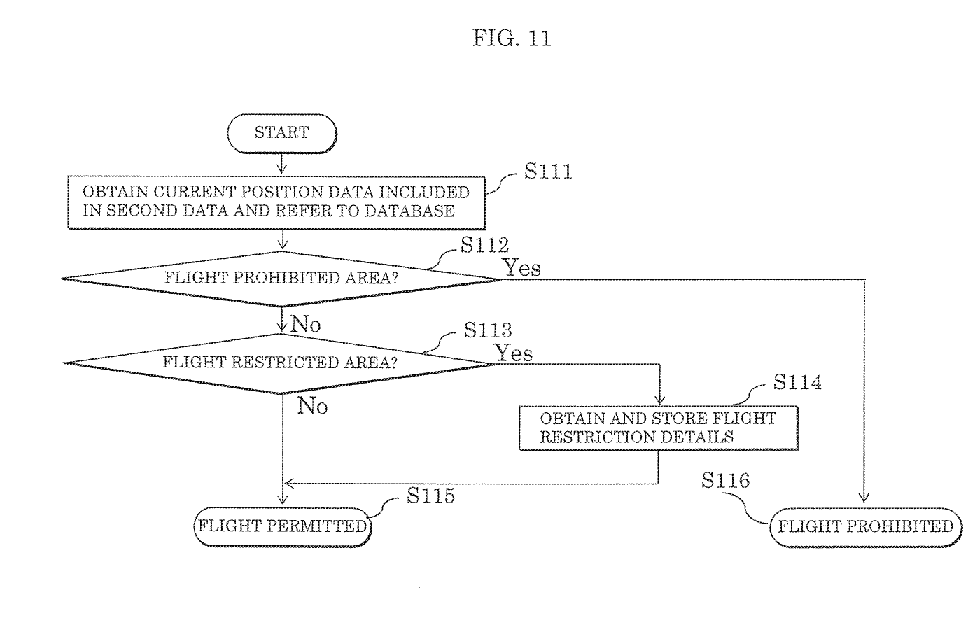

FIG. 11 is a flowchart of another example process of comparison and judgment performed by server 5 of the system.

First, server 5 obtains the current position “35. 004/135. 769 (35 degrees north latitude, 00 minutes 14.4 seconds/135 degrees east longitude, 46 minutes 07.7 seconds)” from the second data, i.e., the data (shown in FIG. 6) read by information communication terminal 3 from mobile object 2 (S111). Server 5 accesses its database D (not illustrated) that stores information on the prohibitions and restrictions on flight to judge whether the value of the obtained “current position” is not against the prohibitions or restrictions on flight. Database D represents information on areas in which flight should be prohibited or restricted as numerical values of latitude and longitude. Areas in which flight should be prohibited or restricted are, for example, densely populated areas, important national facilities, power plants, and privately-owned areas. Plural items are previously set as restriction details for areas in which flight should be restricted. For example, the altitude of flight or the type of a sensor to be used is to be restricted. In particular, from the standpoint of privacy, the use of an image sensor may be restricted when a mobile object flies low in residential areas.

In this comparison and judgment process, server 5 judges whether the value of the obtained “current position” agrees with any of the values of the latitudes and longitudes of the flight prohibited areas or falls within a predetermined rage (S112). Meanwhile, when the current position is in any of the flight prohibited areas (Yes in S112), server 5 terminates the process and returns a response of “flight prohibited” (S116). When the current position is outside of the flight prohibited areas (no hit) (No in S112), server 5 proceeds to the following step.

Then, server 5 judges whether the value of the current position agrees with any of the values of the latitudes and longitudes of the flight restricted areas or falls within a predetermined rage (S113). When the current position is outside of the flight restricted areas (No in S113), server 5 terminates the process and returns a response of “flight permitted” (S115). Meanwhile, when the current position is in any of the flight restricted areas (Yes in S113), server 5 obtains the restriction details from database D, and stores such details onto the recording device to terminate the judgment process (S114). The restriction details stored are transmitted to information communication terminal 3, together with the response of“flight permitted” (S115).

In this example, the current position “35. 004/135. 769” is in the vicinity of Shijo Kawaramachi in Kyoto City, which is a densely populated urban area and thus is previously set as a flight prohibited area in database D. As such, server 5 terminates the comparison and judgment process at the step of judging whether the current position is in a flight prohibited area, and returns a response indicting “flight prohibited.”

Note that upon receiving the response, information communication terminal 3 notifies the user of the judgment result by displaying on the monitor “flight permitted” or “flight prohibited,” together with its reason (e.g., “this is a flight permitted area” or “this is a flight prohibited area”).

As described above, in the present embodiment, at least: mobile object 2 includes an internal IC tag 13; information communication terminal 3 contactlessly reads into information communication terminal 3 the second data of mobile object 2 and transmits the second data to server 5 together with the first data, which is information on mobile object 2 included in mobile object pilot license 1; and server 5 judges whether the flight of mobile object 2 should be permitted on the basis of the first data and the second data, and restricts the operation of mobile object 2 through information communication terminal 3 accordingly. This configuration reliably stops inappropriate use of mobile object 2 and thus enables safe and secure operation of mobile object 2.

Stated differently, the above configuration achieves an expected effect of preventing accidents by providing the following example conditions as a system: a user without license is not even allowed to turn on a mobile object; the flight of an unregistered aircraft is not permitted; a user with insufficient flying skills is only granted flight permission of an aircraft appropriate for the skills of such user (e.g., a small or lightweight aircraft); and flight prohibited or restricted areas (e.g., densely populated area) are previously registered so that the use of a mobile object in the registered areas is prohibited or restricted.

Also, by setting insurance subscription as a requirement for granting flight permission of mobile object 2, certain compensation is provided in the event of an accident, which helps relieving the victim of the accident.

Also, since information can be read from the internal IC tag 13 of mobile object 2 even when mobile object 2 is powered off, it is possible to readily identify the owner of mobile object 2 in the event of an accident such as falling. Accordingly, prompt handling of accidents and reduction of reckless flying of mobile objects itself are expected.

Note that the present embodiment enables the flight of mobile object 2 by turning on the power of mobile object 2 from the off state, depending on a result of a request for flight permission, but the present embodiment is not limited to this example. For example, turning on/off of the power of mobile object 2 may be freely operated at the mobile object side and the flight of mobile object 2 (ascent or travel of mobile object 2) may be controlled in accordance with a signal from information communication terminal 3.

Also in the present embodiment, the flight permission judgment processes 1 and 2 are example judgment processes, and thus the judgment processes 1 and 2 may be combined to achieve certification with high accuracy. Alternatively, only one of the judgment processes 1 and 2 may be performed or a simpler judgment may be performed using a reduced number of conditions. Especially in the case where mobile object 2 is a lightweight toy with low functionality, a simpler judgment may be employed for higher convenience. Meanwhile, in the case where mobile object 2 is a heavyweight mobile object with high functionality for professional use, the information processing system may set a higher bar for certification of flight permission by using an increased number of conditions in a judgment process. Accordingly, the present disclosure can contribute to safe operation of mobile objects.

Also in the present embodiment, the flight permission judgment process 2 may be performed by use of not only “current position” but also data of “date and time” obtained from an internal clock of server 5. For example, the dates and times of previously scheduled festivals and events, such as Kyoto Gion Festival, are previously registered into a database of server 5, together with the positional information of the venues. This allows for returning a response of “flight prohibited” in the case where a request for flight permission sent from mobile object 2 is applicable to any of the dates and times as well as the venues of the festivals and events registered in the database. This configuration prohibits and restricts the flight, only on the specified dates and times, in areas that are usually thinly populated.

Also, in the present embodiment, the structures of the data items read by information communication terminal 3, i.e., the first data of mobile object pilot license 1 and the second data of mobile object 2, as well as the structure of the data items in the databases of server 5 are mere examples, and thus the present disclosure is not limited to the data structures described above.

Also in the present embodiment, the certification of mobile object pilot license 1 may be omitted to simplify the operation of the system. For example, the information processing system of the present disclosure may be a system in which information communication terminal 3 transmits only information on mobile object 2 to server 5, which then performs the comparison and judgment process to check only for flight prohibited and restricted areas on the basis of the current position data and for the insurance on the basis of the individual identification number data, and gives to information communication terminal 3 notification about flight permission and precautions. Alternatively, similar to the above-described embodiment, information communication terminal 3 may transmit a signal for controlling turning on/off of the power as well as the operation of mobile object 2 on the basis of a result of the judgment process.

### Variation 1 of Embodiment 1

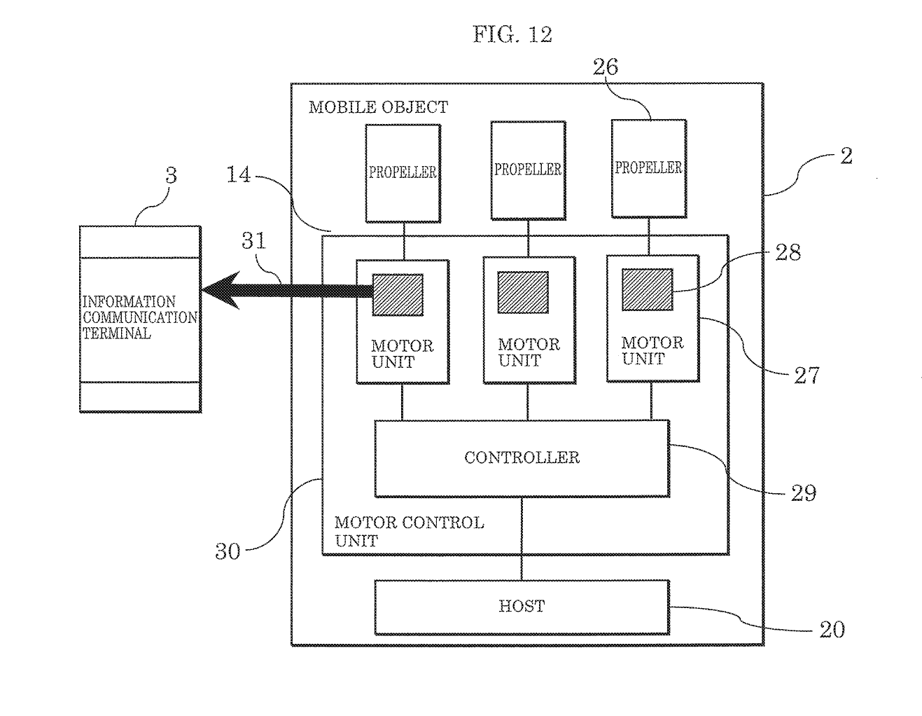

FIG. 12 is a schematic diagram showing a part of the configuration of the information processing system for a mobile object according to Variation 1.

In Embodiment 1, IC tag 13 is disposed in one of the electrical units responsible for flight control, such as the main unit of mobile object 2. Mobile object 2 according to Variation 1 is different from Embodiment 1 in that a plurality of IC tags are further included in motor units connected to a plurality of propellers.

More specifically, as illustrated in FIG. 12, mobile object 2 includes a plurality of propellers 26 and motor units 27 connected to propellers 26. Propellers 26 are wings that rotate to generate power for flying and moving mobile object 2, by being driven by the rotations of the respective motor units 27. Each motor unit 27 may be a motor itself or may be a motor driver that drives the motor. Alternatively, each motor unit 27 may be formed by an integration of a motor and a motor driver.

IC tag 28 is embedded in at least one of a plurality of motor units 27, but IC tag 28 may be embedded in all motor units 27. IC tag 28 includes an antenna and an IC chip that enable mobile object 2 to perform contactless exterior communication. The circuit configuration of IC tag 28 is similar to that of IC tag 13 of Embodiment 1, and thus is not illustrated in the drawing.

Variation 1 is different from Embodiment 1 in that total operation hours of each motor unit 27 counted by controller 29 is recorded into the nonvolatile memory. Alternatively, information on failure of motor units 27 diagnosed by controller 29 may be recorded into the nonvolatile memory. Controller 29 is connected to motor units 27 to serve as a control system of motor control unit 30. Motor control unit 30 is connected to host 20 of mobile object 2.

Data 31 recorded in the nonvolatile memory, such as a total operation hours and failure information of motor units 27, is read by an external device such as information communication terminal 3 through contactless communication. The read information is transmitted from information communication terminal 3 to server 5 over network 4 to be recorded in a database of server 5.

Server 5 stores a database on uptime of the components used for mobile object 2. The arithmetic unit of server 5 compares a total operation hours of motor units 27 with the value of uptime recorded in the database. When judging as a result of comparison that mobile object 2 has been used beyond the length of time that is estimated to be safe for use, server 5 notifies information communication terminal 3 of the judgment result, and information communication terminal 3 subsequently displays on the monitor that it is time for component replacement.

When data 31 includes information indicating that motor unit 27 has a failure, server 5 that has received data 31 accesses database B that stores information on mobile object 2 to rewrite the item “failure” to “present.” This enables server 5 to transmit a response of “flight prohibited,” next time a request for flight permission is made.

As described above, by disposing IC tags 28 in motor units 27 that drive propellers 26, the information processing system for a mobile object according to Variation 1 facilitates the detection of aging of motor units 27 as well as the presence or absence of a failure of motor units 27. Stated differently, the system is capable of keeping track of the states of components even in the power-off state, thereby enabling safe operation of mobile object 2.

The information processing system according to Variation 1 is capable of further enhancing the effect of Embodiment 1. i.e., the effect of achieving safe and secure operation of the mobile object as well as prevention of accidents.

Note that in Variation 1, motor units 27 include IC tags 28, but the present disclosure is not limited to this example, and thus another component of mobile object 2 may include an IC tag to be used for the judgment of flight permission, failure prediction, or maintenance notice.

Also note that information communication terminal 3 reads from IC tag 28 aging information and failure information of motor units 27 in the above-description, but the present disclosure is not limited to this example. Such items of information, for example, may be transferred to memory 19 of IC tag 13 disposed in the main unit of mobile object 2 so that such items of information can be read from IC tag 13.

### Variation 2 of Embodiment 1

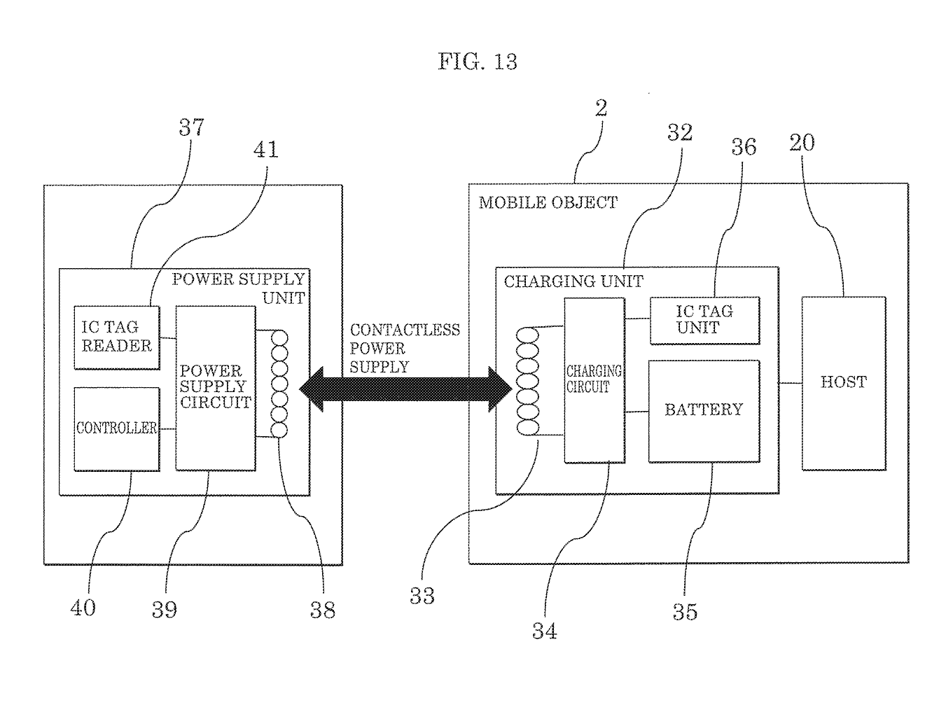

FIG. 13 is a schematic diagram showing a part of the configuration of the information processing system for a mobile object according to Variation 2.

A long-lasting battery is one of the current challenges in the use of a mobile object. A larger battery capacity increases the total amount of power supply, and also the weight of the mobile object accordingly. This is a big challenge for an aircraft such as a drone.

To cope with the challenge regarding batteries, Variation 2 aims to provide a power supply means other than wired power supply means. In the information processing system according to Variation 2, power is contactlessly supplied to the battery of the mobile object.

More specifically, as illustrated in FIG. 13, mobile object 2 includes charging unit 32 that is connected to the main unit including host 20. Charging unit 32 includes power receiving coil 33, charging circuit 34 connected to power receiving coil 33, and battery 35 connected to charging circuit 34. Charging circuit 34 includes: a rectification circuit that converts power induced by power receiving coil 33 to a direct-current voltage; a smoothing circuit that smoothens the power; a DC to DC converter; and a control circuit that controls the charge to the battery.

Charging unit 32 further includes IC tag unit 36 connected to power receiving coil 33. IC tag unit 36 is configured to operate in the same manner as an IC tag when IC tag unit 36 is connected to power receiving coil 33 (antenna).

Power supply unit 37, which is an external device of mobile object 2, may be a power supply spot disposed, for example, at the roof of a building. Power supply unit 37 may also be a power supply device incorporated in a mobile object other than mobile object 2. In this case, such another mobile object may be configured as an aircraft, the main purpose of which is power charging, and which accesses mobile object 2 in flight to contactlessly charge power midair.

Power supply unit 37 includes power transmission coil 38, power supply circuit 39 that generates power to supply to power transmission coil 38, controller 40 that controls power supply circuit 39, and IC tag reader 41 that identifies an external device to charge power to. IC tag reader 41 operates when in connection with power transmission coil 38 (antenna).

When mobile object 2 approaches power supply unit 37, IC tag reader 41 detects IC tag unit 36 of mobile object 2 via the antennas (power receiving coil 33 and power transmission coil 38). Controller 40 obtains a command recorded in a memory of IC tag unit 36 to judge whether mobile object 2 is an object to charge power to. When judging that power should be charged to mobile object 2, controller 40 activates power supply circuit 39 to cause power supply circuit 39 to discharge. Contactless power charging is carried out using electromagnetic induction via power transmission coil 38 and power receiving coil 33.

As described above, in the information processing system according to Variation 2, mobile object 2 includes charging unit 32 capable of contactless power charging, thereby enabling power charring other than by wire.

### Variation 3 of Embodiment 1

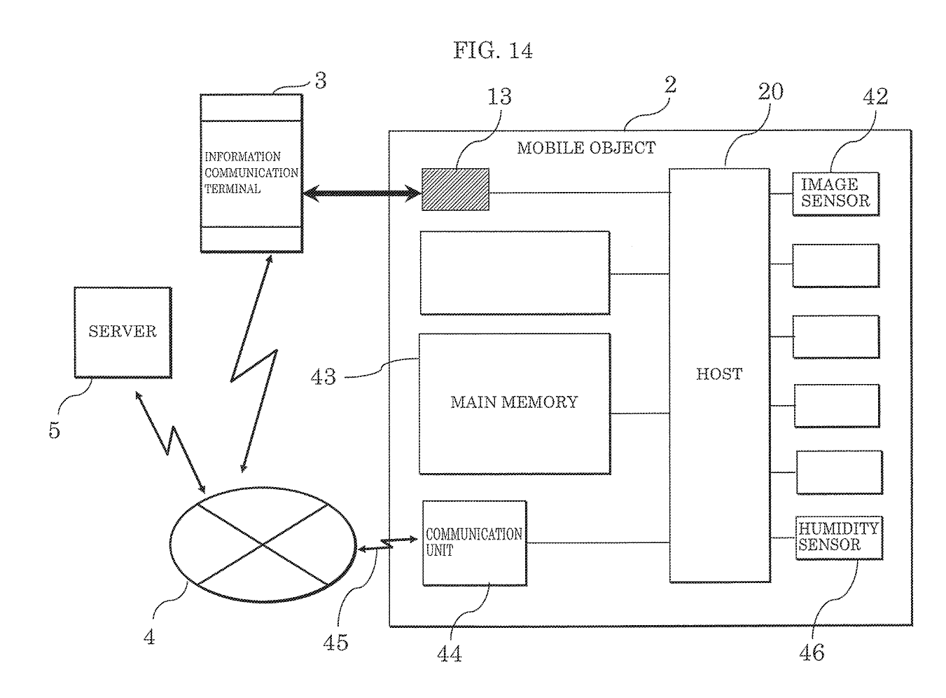

FIG. 14 is a schematic diagram showing a part of the configuration of the information processing system for a mobile object according to Variation 3.

Embodiment 1 discloses that information obtained by position sensor 21 of mobile object 2 is transmitted from information communication terminal 3 to server 5. However, a sensor included in mobile object 2 may be a sensor other than position sensor 21. For example, a sensor in mobile object 2 may be an image sensor for photography and a sound sensor, as well as a sensor for keeping track of the environment such as a temperature sensor, a humidity sensor, a wind speed sensor, a pressure sensor, an altitude sensor, and an acceleration sensor, and data obtained by any of these sensors may be provided to server 5.

In Variation 3, first, an example will be described in which mobile object 2 communicates with server 5 over network 4 on the basis of data obtained by an image sensor.

As illustrated in FIG. 14, host 20 stores data of an image taken by image sensor 42 into main memory 43 of mobile object 2. In so doing, host 20 accesses memory 19 of IC tag 13 to obtain the data of the operator information (e.g., license number) stored at the time of certifying mobile object 2 for flight permission, and stores into main memory 43 such obtained data and the image data in a set. Here, the image data is a still image or a moving image.

Mobile object 2 includes communication unit 44 that communicates with network 4, in addition to IC tag 13, which is a contactless communication unit. Host 20 accesses a region in main memory 43 in which the image data is stored, and transmits data 45, which is a set of the image data and the operator information, from communication unit 44 to an external network 4. Data 45 is then stored into the recording device of server 5 over network 4.

In the above-described example, data obtained by a sensor such as image sensor 42 included in mobile object 2 is stored into the recording device of server 5 together with the license number in a set. Accordingly, it is possible for data of images taken by the user (operator) using a different owner's mobile object, such as a rented aircraft, to be stored into server 5 together with the operator information. Server 5 may transmit the data stored in the recording device to another electric device terminal over network 4, in accordance with a user's request.

Next, an example will be described in which mobile object 2 communicates with server 5 on the basis of data obtained by a humidity sensor. Data communication with IC tag 13 is carried out in the same manner as that of the position sensor of Embodiment 1, and thus will not be described in detail.

As illustrated in FIG. 14, in the step in which information communication terminal 3 reads information of mobile object 2, host 20 supplies power to humidity sensor 46 so that humidity sensor 46 can measure the humidity of the outside of mobile object 2. The humidity data is read by information communication terminal 3 through contactless communication via IC tag 13 to be transmitted to server 5 over network 4.

Server 5 determines a mode, using the humidity data as an argument. For example, when determining a mode with the humidity of 80%, mobile object 2 judges that it is rainy outside of mobile object 2. According to the judgment result, a control program for “Rainy Mode” is selected from the control programs stored in the recording device of server 5.

Server 5 establishes a communication with mobile object 2 over network 4, and transmits to communication unit 44 the control program for “Rainy Mode” corresponding to the external environment of mobile object 2. Host 20 downloads such control program and sets a flight controller to carry out flight in accordance with the program.

“Rainy Mode” is, for example, a mode in which the maximum speed of mobile object 2 is set low because of low visibility. The flight controller controls the electrical units such as the motor unit in accordance with the mode having been set.

In the above-described example, data obtained by a sensor, such as humidity sensor 46, that keeps track of the external environment of mobile object 2 is transmitted to sever 5 on a request for flight permission, and server 5 determines a flight mode in accordance with the data of the sensor, in addition to making a judgment for flight permission, so that a control program appropriate for the judgment result is set to mobile object 2. This achieves safer and more secure operation of mobile object 2.

### Variation 4 of Embodiment 1

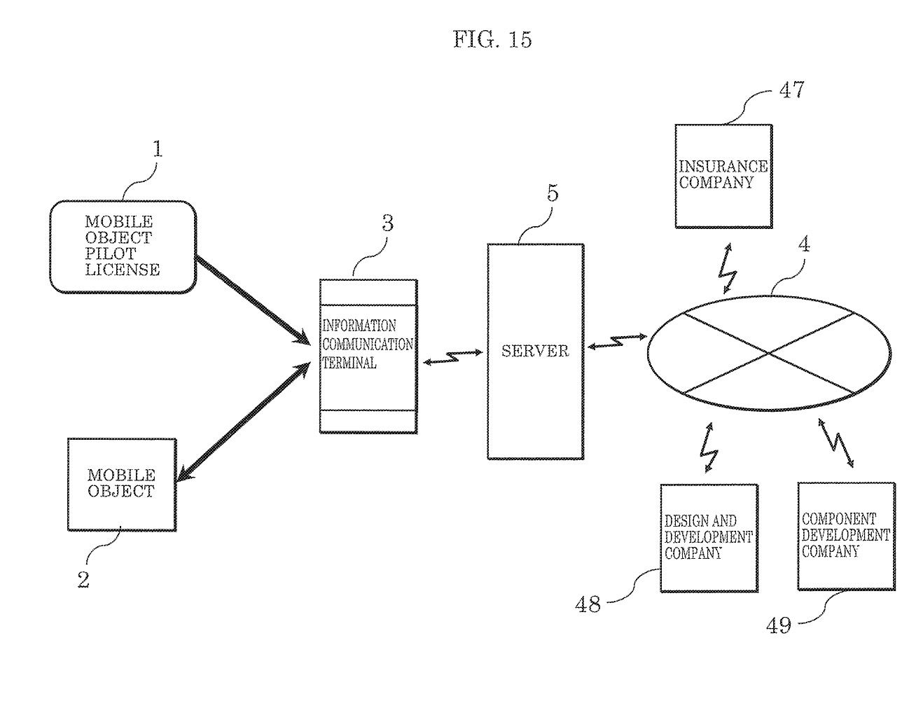

FIG. 15 is a schematic diagram showing the configuration of the information processing system for a mobile object according to Variation 4.

In Variation 4, server 5 processes information obtained in Embodiment 1 and Variations 1 to 3 of Embodiment 1 described above, and transmits the resulting information to an external organization over network 4.

Server 5 stores in its recording device the information obtained from mobile object pilot license 1 and mobile object 2 via information communication terminal 3, as well as the information received from mobile object 2 over network 4. Server 5 further stores in its recording device the results of the comparison and judgment processes that have been performed by use of the first data and the second data, as well as the databases updated according to the results.

As illustrated in FIG. 15, server 5 transmits information to an external server or terminal over network 4. Here, the external server or terminal is, for example, a server or a terminal located in insurance company 47, design and development company 48 of the mobile object, or component development company 49 of the mobile object. The external server or terminal may also be a server or a terminal possessed by the dealer of the mobile object, a repair shop, or an academic research institute.

As described above, server 5 performs a predetermined process on data stored in its recording device, and transmits the resulting data to an external server or terminal over network 4.

As described above, the information processing system according to Variation 4 utilizes the information on mobile object 2 and the failure information of its components stored in the server for the design, development or repairmen of mobile objects, thereby contributing to the achievement of mobile objects with increased safety and reliability. Furthermore, by utilizing the information on failure or accidents corresponding to the types of mobile objects or components, the present system contributes to the development of more suitable insurance products, and thus achieves safer and more secure operation of the mobile object.

### Variation 5 of Embodiment 1

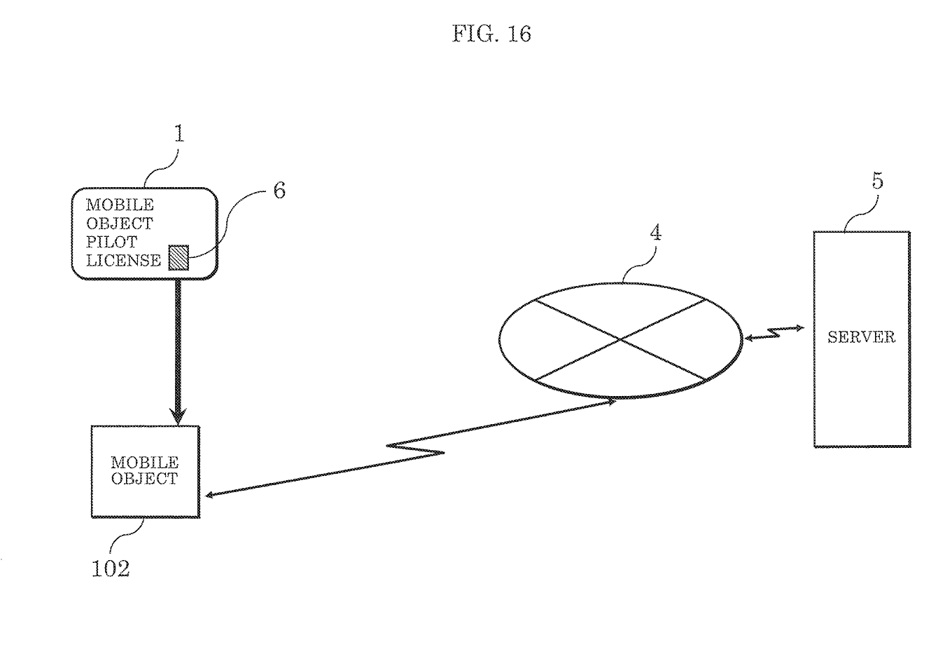

FIG. 16 is a schematic diagram showing the configuration of the information processing system for a mobile object according to Variation 5.

In Variation 5, the functions of information communication terminal 3 according to Embodiment 1 are centralized in the mobile object.

More specifically, as illustrated in FIG. 16, mobile object 102 includes a contactless interface that enables mobile object 102 to contactlessly communicate with mobile object pilot license 1, and has reader/writer function to be performed on IC tag 6. Mobile object 2 is configured to communicate also with network 4. With this configuration, mobile object 102 may include a subscriber identity module (SIM) card.

In Variation 5, mobile object 102 is required to include no IC tag, and thus the information on mobile object 102 (the second data) to be transmitted to server 5 is simply required to be stored in a memory region in mobile object 102 accessible by the host.

With this configuration, the information on mobile object pilot license 1 (the first data) is read by mobile object 102 through contactless communication, and then transmitted from mobile object 102 directly to server 5 over network 4, together with the second data (transmitted as a request). A response from server 5 including judgment result 25 is directly received by mobile object 102 over network 4.

Upon receiving the response from server 5, mobile object 102 stores data included in the response signal into a memory, and generates an internal signal corresponding to the response so as to perform a control such as turning on of the power.

As in the case of Embodiment 1, the information processing system according to Variation 5 enables safe and secure operation of mobile object 102. Moreover, by providing mobile object 102 with centralized functions for communicating with mobile object pilot license 1 and server 5, the information processing system is required to perform simpler processing, which results in the effect of reducing the number of operations the user is required to perform.

As described above, the information processing system for a mobile object according to one aspect of the present disclosure is an information processing system for a mobile object including: a mobile object pilot license; a mobile object including a first IC tag; an information communication terminal that contactlessly communicates with the mobile object; and a server that communicates with the information communication terminal over a network. In this system, the information communication terminal transmits first data and second data to the server, the first data being data on the mobile object pilot license, the second data being data on the mobile object read into the information communication terminal through contactless communication, the server performs a predetermined judgment process based on the first data and the second data, and transmits third data that is based on a result of the predetermined judgment process to the information communication terminal, and the information communication terminal transmits a signal corresponding to the third data to the mobile object to permit or restrict an operation of the mobile object in accordance with the signal.

For example, the first IC tag may include a first antenna, a first nonvolatile memory, a first contactless communication unit, and a contact communication unit, and the first data may be recorded in the first nonvolatile memory, and may be read into the information communication terminal through contactless communication via the first contactless communication unit and the first antenna.

For example, the mobile object pilot license may include a second IC tag, the second IC tag may include a second antenna, a second nonvolatile memory, and a second contactless communication unit, and the first data may be recorded in the second nonvolatile memory, and may be read into the information communication terminal through contactless communication via the second contactless communication unit and the second antenna.

For example, the third data may include information on any one of permission to activate the mobile object, a restriction on a travel range, a functional restriction, a maintenance status, time for component replacement, a remaining battery level, an operation mode, a program update, owner information of the mobile object, and owner information of the mobile object pilot license, and the information communication terminal may display on a monitor the information included in the third data.

For example, the mobile object may be powered on in accordance with the signal transmitted from the information communication terminal and corresponding to the third data.

For example, when in a power-on state, the mobile object may communicate with the server over the network to transmit image data to the server or to download a control program from the server.

For example, the first data may include at least license number information of the mobile object pilot license, the second data may include information on the mobile object indicating any one of an individual identification number, a current position, a failure, and an external environment, and the server may perform the predetermined judgment process based on the first data and the second data, and may store the first data and the second data into an internal recording device of the server.

For example, the server may perform a predetermined process on the data stored in the internal recording device, and may transmit the data that has been processed to one of a design entity, a dealer entity, and an insurance entity of the mobile object over the network, the data being transmitted from the mobile object or the mobile object pilot license.

For example, the mobile object may include an electrical unit that includes a host controller, and a battery that supplies power to the electrical unit, and the battery may be connected to a charging unit that includes a power receiving coil, a rectification circuit, a smoothing circuit, and a charging control circuit, and may be externally charged through contactless power supply via the power receiving coil.

For example, the battery may be charged, while the mobile object is in operation, from another mobile object through contactless communication, the other mobile object including a power transmission coil for power supply and a power supply circuit.

For example, the mobile object may be an aircraft including a plurality of propellers, and may include a plurality of motor units that rotate the plurality of propellers, each of the plurality of motor units being connected to a different one of the plurality of propellers, and at least one of the plurality of motor units may include a third IC tag that incorporates a third nonvolatile memory, and at least one of operation hours and the presence or absence of a failure of the at least one of the plurality of motor units may be recorded in the third nonvolatile memory.

For example, the mobile object may include a fourth nonvolatile memory, and a sensor of any one of image, temperature, humidity, position, altitude, acceleration, pressure, and sound, and data obtained by the sensor may be recorded into a main memory of the mobile object as fourth data associated with the first data, and may be transmitted to the server over the network.

For example, the mobile object may include a sensor of any one of image, temperature, humidity, position, altitude, acceleration, pressure, and sound, information obtained by the sensor may be read into the information communication terminal through contactless communication, and then transmitted to the server over the network, and the server may make a judgment on an external environment of the mobile object based on the information obtained by the sensor, and may transmit the signal to the mobile object via the information communication terminal, the signal prohibiting or restricting the operation of the mobile object depending on a result of the judgment.

For example, the mobile object may include a sensor of any one of image, temperature, humidity, position, altitude, acceleration, pressure, and sound, information obtained by the sensor may be transmitted to the server, and the server may make a judgment on an external environment of the mobile object based on the information obtained by the sensor, and may transmit a control program for a specific operation mode to the mobile object over the network depending on a result of the judgment.

Moreover, the server for managing a mobile object according to another aspect of the present disclosure is a server for managing a mobile object, including: a communication unit that communicates over a network with an information communication terminal capable of contactless communication; a data obtainment unit that obtains first data and second data from the information communication terminal and records the first data and second data that have been obtained, the first data being data on a mobile object pilot license, the second data being data on the mobile object read from an internal IC tag of the mobile object through contactless communication; and a judgment unit that performs a predetermined judgment process based on the first data and the second data, and generates third data that is based on a result of the predetermined judgment process. Here, the server transmits the third data to the information communication terminal over the network so that the information communication terminal transmits a signal corresponding to the third data to the mobile object to permit or restrict an operation of the mobile object in accordance with the signal.

Moreover, the information communication terminal according to still another aspect of the present disclosure is an information communication terminal including: a first communication unit that reads into the information communication terminal second data from a mobile object including a first IC tag through contactless communication, the second data being data on the mobile object; and a second communication unit that transmits the second data and first data to a server over a network, the first data being data on a mobile object pilot license. In the information communication terminal, the second communication unit receives third data that is based on a result of a predetermined judgment process performed by the server based on the first data and the second data, and the first communication unit transmits a signal corresponding to the third data to the mobile object through contactless communication to permit or restrict an operation of the mobile object in accordance with the signal.

For example, the first communication unit may read into the information communication terminal the second data from a second IC tag included in the mobile object pilot license through contactless communication.

Moreover, the mobile object according to still another aspect of the present disclosure is a mobile object including a first IC tag that contactlessly communicates with an information communication terminal, the first IC tag including a first nonvolatile memory storing second data, a first antenna, and a first communication unit, Here, the mobile object transmits the second data to the information communication terminal through contactless communication via the first antenna and the first communication unit so that the information communication terminal that has received the second data transmits the second data together with first data to a server over a network, the first data being data on a mobile object pilot license, receives a signal from the information communication terminal through contactless communication, the signal corresponding to third data that is received by the information communication terminal over the network, and that is a result of a judgment process performed by the server based on the first data and the second data, and controls an own operation based on the signal corresponding to the third data.

Moreover, the information processing system according to still another aspect of the present disclosure is an information processing system for a mobile object, including: a mobile object including a first IC tag; an information communication terminal that contactlessly communicates with the mobile object; and a server that communicates with the information communication terminal over a network. Here, the information communication terminal transmits to the server second data that is data on the mobile object read into the information communication terminal through contactless communication, the server performs a predetermined judgment process based on the second data, and transmits third data that is based on a result of the predetermined judgment process to the information communication terminal, and the information communication terminal displays on a monitor information that is based on the third data.

For example, the information communication terminal may transmit a signal corresponding to the second data to the mobile object to permit or restrict an operation of the mobile object in accordance with the signal.

Moreover, the information processing system according to still another aspect of the present disclosure is an information processing system for a mobile object, including: a mobile object pilot license including a second IC tag; a mobile object that contactlessly communicates with the mobile object pilot license; and a server that communicates with the mobile object over a network. Here, the mobile object transmits first data and second data to the server, the first data being data on the mobile object pilot license read into the mobile object through contactless communication, the second data being data on the mobile object stored in an internal memory of the mobile object, and the server performs a predetermined judgment process based on the first data and the second data, and transmits to the mobile object a signal including third data that is based on a result of the predetermined judgment process to permit or restrict an operation of the mobile object in accordance with the signal including the third data.

The present disclosure has been described in detail on the basis of an embodiment and variations of the embodiment, but the present disclosure is not limited to the foregoing embodiment and variations. Any modifications and changes may thus be made therein without departing from the essence of the present disclosure. For example, one or more structural components of the present disclosure may be replaced by one or more components not described in the embodiment to be included in the scope of the present disclosure. Moreover, a combination of a plurality of embodiments and a combination of a plurality of variations are also included in the scope of the present disclosure.

Also note that each of the processing units included in each device according to the foregoing embedment is implemented as an LSI, which is typically an integrated circuit. Each of these processing units may be separately implemented as a single chip, or one or more or all of the processing units may be integrated into a single chip

Also, the processing units may not necessarily be implemented as an LSI, and thus may be implemented as a dedicated communication circuit or as a general-purpose processor. Alternatively, a field programmable gate array (FPGA) that allows for programming after the manufacture of an LSI, or a reconfigurable processor that allows for reconfiguration of the connection and setting of circuit cells inside an LSI may also be employed.

Also, one or more or all of the functions of each processing unit included in each device according to the foregoing embodiment may be implemented by the execution of a program by a processor such as a CPU.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing a plurality of steps shown in the flowcharts is a mere illustration for specifically describing the present disclosure, and thus may be an order other than the shown order. Also, one or more of the steps may be executed simultaneously (in parallel) with another step.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure is useful as a system for managing the operation of a remotely controlled autonomous locomotion robot.

What is claimed is:

1. An information processing system for a mobile object, the system comprising:
a mobile object pilot license;
a mobile object including a first IC tag;
an information communication terminal that contactlessly communicates with the mobile object; and
a server that communicates with the information communication terminal over a network,
wherein the information communication terminal transmits first data and second data to the server, the first data being data on the mobile object pilot license, the second data being data on the mobile object read into the information communication terminal through contactless communication,
the server performs a predetermined judgment process based on the first data and the second data, and transmits third data that is based on a result of the predetermined judgment process to the information communication terminal, and
the information communication terminal transmits a signal corresponding to the third data to the mobile object to permit or restrict an operation of the mobile object in accordance with the signal.

2. The information processing system according to claim 1,
wherein the first IC tag includes a first antenna, a first nonvolatile memory, a first contactless communication unit, and a contact communication unit, and
the first data is recorded in the first nonvolatile memory, and is read into the information communication terminal through contactless communication via the first contactless communication unit and the first antenna.

3. The information processing system according to claim 1,
wherein the mobile object pilot license includes a second IC tag,
the second IC tag includes a second antenna, a second nonvolatile memory, and a second contactless communication unit, and
the first data is recorded in the second nonvolatile memory, and is read into the information communication terminal through contactless communication via the second contactless communication unit and the second antenna.

4. The information processing system according to claim 1,
wherein the third data includes information on any one of permission to activate the mobile object, a restriction on a travel range, a functional restriction, a maintenance status, time for component replacement, a remaining battery level, an operation mode, a program update, owner information of the mobile object, and owner information of the mobile object pilot license, and
the information communication terminal displays on a monitor the information included in the third data.

5. The information processing system according to claim 1,
wherein the mobile object is powered on in accordance with the signal transmitted from the information communication terminal and corresponding to the third data.

6. The information processing system according to claim 5,
wherein when in a power-on state, the mobile object communicates with the server over the network to transmit image data to the server or to download a control program from the server.

7. The information processing system according to claim 1,
wherein the first data includes at least license number information of the mobile object pilot license,
the second data includes information on the mobile object indicating any one of an individual identification number, a current position, a failure, and an external environment, and
the server performs the predetermined judgment process based on the first data and the second data, and stores the first data and the second data into an internal recording device of the server.

8. The information processing system according to claim 7,
wherein the server performs a predetermined process on the data stored in the internal recording device, and transmits the data that has been processed to one of a design entity, a dealer entity, and an insurance entity of the mobile object over the network, the data being transmitted from the mobile object or the mobile object pilot license.

9. The information processing system according to claim 1,
wherein the mobile object includes an electrical unit that includes a host controller, and a battery that supplies power to the electrical unit, and
the battery is connected to a charging unit that includes a power receiving coil, a rectification circuit, a smoothing circuit, and a charging control circuit, and is externally charged through contactless power supply via the power receiving coil.

10. The information processing system according to claim 9,
wherein the battery is charged, while the mobile object is in operation, from another mobile object through contactless communication, the other mobile object including a power transmission coil for power supply and a power supply circuit.

11. The information processing system according to claim 1,
wherein the mobile object is an aircraft including a plurality of propellers, and includes a plurality of motor units that rotate the plurality of propellers, each of the plurality of motor units being connected to a different one of the plurality of propellers, and
at least one of the plurality of motor units includes a third IC tag that incorporates a third nonvolatile memory, and at least one of operation hours and the presence or absence of a failure of the at least one of the plurality of motor units is recorded in the third nonvolatile memory.

12. The information processing system according to claim 1,
wherein the mobile object includes a fourth nonvolatile memory, and a sensor of any one of image, temperature, humidity, position, altitude, acceleration, pressure, and sound, and
data obtained by the sensor is recorded into a main memory of the mobile object as fourth data associated with the first data, and is transmitted to the server over the network.

13. The information processing system according to claim 1,
wherein the mobile object includes a sensor of any one of image, temperature, humidity, position, altitude, acceleration, pressure, and sound,
information obtained by the sensor is read into the information communication terminal through contactless communication, and then transmitted to the server over the network, and
the server makes a judgment on an external environment of the mobile object based on the information obtained by the sensor, and transmits the signal to the mobile object via the information communication terminal, the signal prohibiting or restricting the operation of the mobile object depending on a result of the judgment.

14. The information processing system according to claim 1,
wherein the mobile object includes a sensor of any one of image, temperature, humidity, position, altitude, acceleration, pressure, and sound,
information obtained by the sensor is transmitted to the server, and
the server makes a judgment on an external environment of the mobile object based on the information obtained by the sensor, and transmits a control program for a specific operation mode to the mobile object over the network depending on a result of the judgment.

15. A server for managing a mobile object, the server comprising:
a communication unit that communicates over a network with an information communication terminal capable of contactless communication;
a data obtainment unit that obtains first data and second data from the information communication terminal and records the first data and second data that have been obtained, the first data being data on a mobile object pilot license, the second data being data on the mobile object read from an internal IC tag of the mobile object through contactless communication; and
a judgment unit that performs a predetermined judgment process based on the first data and the second data, and generates third data that is based on a result of the predetermined judgment process,
wherein the server transmits the third data to the information communication terminal over the network so that the information communication terminal transmits a signal corresponding to the third data to the mobile object to permit or restrict an operation of the mobile object in accordance with the signal.

16. An information communication terminal comprising:
a first communication unit that reads into the information communication terminal second data from a mobile object including a first IC tag through contactless communication, the second data being data on the mobile object; and
a second communication unit that transmits the second data and first data to a server over a network, the first data being data on a mobile object pilot license,
wherein the second communication unit receives third data that is based on a result of a predetermined judgment process performed by the server based on the first data and the second data, and
the first communication unit transmits a signal corresponding to the third data to the mobile object through contactless communication to permit or restrict an operation of the mobile object in accordance with the signal.

17. The information communication terminal according to claim 16,
wherein the first communication unit reads into the information communication terminal the second data from a second IC tag included in the mobile object pilot license through contactless communication.

18. A mobile object comprising a first IC tag that contactlessly communicates with an information communication terminal, the first IC tag including a first nonvolatile memory storing second data, a first antenna, and a first communication unit,
wherein the mobile object transmits the second data to the information communication terminal through contactless communication via the first antenna and the first communication unit so that the information communication terminal that has received the second data transmits the second data together with first data to a server over a network, the first data being data on a mobile object pilot license,
receives a signal from the information communication terminal through contactless communication, the signal corresponding to third data that is received by the information communication terminal over the network, and that is a result of a judgment process performed by the server based on the first data and the second data, and
controls an own operation based on the signal corresponding to the third data.

19. An information processing system for a mobile object, the system comprising:
a mobile object including a first IC tag;
an information communication terminal that contactlessly communicates with the mobile object; and
a server that communicates with the information communication terminal over a network,
wherein the information communication terminal transmits to the server second data that is data on the mobile object read into the information communication terminal through contactless communication,
the server performs a predetermined judgment process based on the second data, and transmits third data that is based on a result of the predetermined judgment process to the information communication terminal, and
the information communication terminal displays on a monitor information that is based on the third data, and transmits a signal corresponding to the second data to the mobile object to permit or restrict an operation of the mobile object in accordance with the signal.

20. An information processing system for a mobile object, the system comprising:
a mobile object pilot license including a second IC tag;
a mobile object that contactlessly communicates with the mobile object pilot license; and
a server that communicates with the mobile object over a network,
wherein the mobile object transmits first data and second data to the server, the first data being data on the mobile object pilot license read into the mobile object through contactless communication, the second data being data on the mobile object stored in an internal memory of the mobile object, and
the server performs a predetermined judgment process based on the first data and the second data, and transmits to the mobile object a signal including third data that is based on a result of the predetermined judgment process to permit or restrict an operation of the mobile object in accordance with the signal including the third data.
